(19) United States
(12) Patent Application Publication
(10) Pub. No.: US 2005/0060234 A1
(43) Pub. Date: Mar. 17, 2005

(54) Method and system for preparing state income tax withholding

(76) Inventor: Tom Reahard, Scottsdale, AZ (US)

Correspondence Address: SANDRA L. ETHERTON;ETHERTON LAW GROUP, LLC, PO BOX 27843, TEMPE, AZ, 85285-7843, US

(21) Appl. No.: 10/910,930

(22) Filed: Aug. 3, 2004

Related U.S. Application Data
(60) Provisional application No. 60/503,352, filed on Sep. 15, 2003.

(51) Int. Cl. G06F 17/60

(52) U.S. Cl. 705/19

(57) ABSTRACT

A method and system uses computer readable program code devices to create an employee state tax exemption certificate form. The method includes saving a data dictionary on a server, where the dictionary includes data fields for employee information, employer information, tax parameter information, and control information. The employee information is used to select an employee exemption certificate form. One or more data fields in the employee exemption certificate form is then populated using information from the data dictionary, and the form is sent to a browser accessible by an employee. The employee then adds additional information into the employee exemption certificate form from the browser to create an updated form. Finally, the updated form is submitted to the server where data is extracted and stored.

### CROSS-REFERENCE TO RELATED APPLICATIONS

This application claims the benefit of co-pending U.S. Provisional Application No. 60/503,352 filed Sep. 15, 2003.

### FIELD OF INVENTION

This invention relates to a method and apparatus for data processing. This invention relates particularly to a method and apparatus for collecting, calculating, and recording data for processing and submitting state income tax withholding forms.

### BACKGROUND

The federal government requires federal income tax to be withheld from every employee's paycheck, with some limited exceptions. The amount to be withheld is calculated on a W-4 form using unique data provided by each employee, including the number of exemptions the employee wants to claim. The W-4 form is therefore also known as an employee exemption certificate. Computerized systems are available, both online and offline, that assist the employee in preparing the W-4 form. The W-4 forms are submitted, either on paper or electronically, to the employer and in some cases to the Internal Revenue Service. A new W-4 form must be generated each time an employee's tax status changes, and in many companies the human resources department requires employees to complete new exemption certificates at the start of each new year.

Similarly, most states and territories require that state income tax be withheld, but some states do not. For those states that require state withholding, each has a different method of determining how much is withheld. Some states require the use of a specific state form, some accept the federal W-4 form, and at least one does not require a form. For the states that require the use of a form, some states require that the form be submitted for all employees, but other states require the form to be submitted only when certain exemptions are claimed. Like the federal system, a new form must be generated each time an employee's tax status changes.

Unlike the federal system, however, no computerized system is available for the preparation of multiple states' forms, or even for the determination of whether a state form is needed. Historically this work has been done manually, with human relations and payroll departments collecting each employee's information, collating the data, making calculations, and submitting the appropriate forms. For employers with many employees across many states, the administrative burden is very high.

To complicate matters further, federal and state tax laws are constantly changing, thereby affecting the amounts to be withheld and the forms to be used. The withholding information must be stored and, for electronic information, retrievable in the format of the year the data was applied, in the event of an audit. It is important to use the latest calculations and forms, and to be able to retrieve stored data in the desired format years after the associated tax laws have changed.

Because withholding affects the amount of take-home pay, employees are keenly interested in knowing the exact amount that will be withheld. Many events can change an employee's tax status, and most of those are life-changing, such as marriage (or divorce), birth of a child, promotion, or relocation to a new state. Consequently, employers are deluged with requests from employees wanting to know not only what the take-home pay is currently, but what it will be upon certain “what-if” events. This adds to the administrative burden on the employer. It would be desirable to provide a system that enables the employee to determine the withheld amounts and to change his or her exemptions, without the aid of the employer. Such a system must also be designed with security and privacy in mind. It would be desirable to provide a system so that no data leaves the corporate intranet. In sum, It would be desirable to have a single, automated system to manage electronic filing of all of the various state exemption certificates.

The following information is important to understand when designing an electronic tax filing system. The text is taken from IRS Publication 15-A, (Rev. January 2003) Cat. No. 21453T, pages 2 and 3:
“You may set up a system to electronically receive any or all of the following forms from an employee or payee:
   Form W-4, Employee's Withholding Allowance Certificate
   Form W-4P, Withholding Certificate for Pension or Annuity Payments
   Form W-4S, Request for Federal Income Tax Withholding From Sick Pay
   Form W-4V, Voluntary Withholding Request
   Form W-5, Employee's Advance Earned Income
“If you establish an electronic system to receive any of these forms, you do not need to process that form in a paper version. For each form that you establish an electronic submission system for, you must meet the following requirements:
   1) “The electronic system must ensure that the information received by the payer is the information sent by the payee. The system must document all occasions of user access that result in a submission. In addition, the design and operation of the electronic system, including access procedures, must make it reasonably certain that the person accessing the system and submitting the form is the person identified on the form.

2) “The electronic system must provide exactly the same information as the paper form.

3) “The electronic submission must be signed with an electronic signature by the payee whose name is on the form. The electronic signature must be the final entry in the submission.

4) “Upon request, you must furnish a hard copy of any completed electronic form to the IRS and a statement that, to the best of the payer's knowledge, the electronic form was submitted by the named payee. The hard copy of the electronic form must provide exactly the same information as, but need not be a facsimile of, the paper form. For Forms W-4 and W-5, the signature must be under penalty of perjury, and must contain the same language that appears on the paper version of the form. The electronic system must inform the employee that he or she must make a declaration contained in the perjury statement and that the declaration is made by signing the Form W-4 or W-5.

5) “You must meet all record keeping requirements that apply to the paper forms.
“For more information, see:
   Form W-4—Regulations section 31.3402(f)(5)-1
   Form W-5—Announcement 99-3”

### SUMMARY OF THE INVENTION

The present invention is therefore an automated method and system for processing employee state tax income exemption certificates. A data dictionary contains fields for one or more of employee, employer organization, tax and control data categories to determine and populate an appropriate state employee exemption certificate form. An employee can access the form from a browser. The employee enters data into the form from the browser, and preferably the data is validated and tax calculations are made. After completing an electronic signature process, the employee submits the completed form to the employer's server for storage. The employer may update its payroll records with the submitted information and retrieve it on demand. Preferably the method is carried out over the organization's intranet.

### BRIEF DESCRIPTION OF THE DRAWINGS

FIG. 1 is a simplified schematic diagram of a system according to one embodiment of the present invention;

FIG. 2A is an illustration of an instructions section of an electronic copy of a state employee exemption certificate form according to an embodiment of the present invention;

FIG. 2B is an illustration of a submission section of an electronic copy of a state employee exemption certificate form according to an embodiment of the present invention; and

FIG. 3 is a simplified flow diagram of a method according to one embodiment of the present invention.

### DETAILED DESCRIPTION OF THE INVENTION

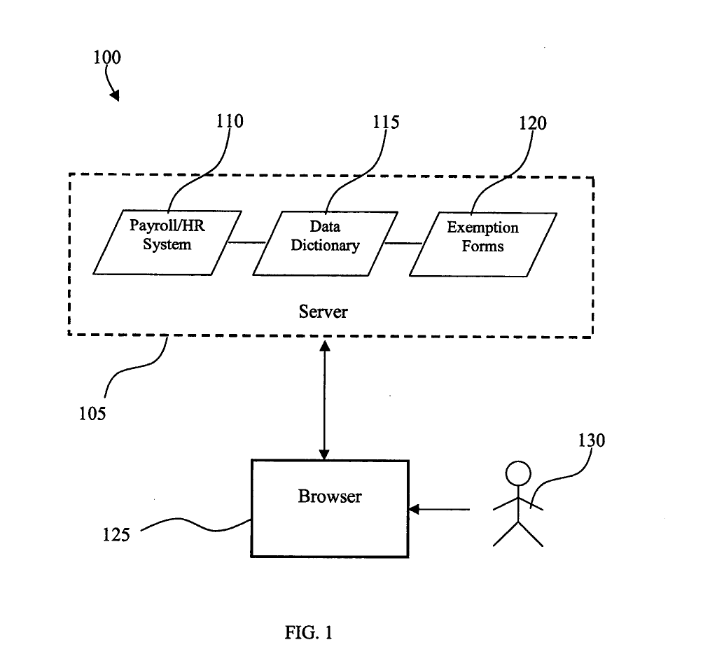

Referring to FIG. 1, there is illustrated a simplified schematic diagram of the system 100 of the present invention. An employer's server 105 includes a system 110 containing payroll data, human relations data, or both (referred to herein as payroll/HR system 110), a data dictionary 115, and electronic federal and state employee exemption certificate forms 120. The system 100 of the invention also includes a browser 125, which may be operated by an employee 130. Data from the payroll/HR system 110 and from the data dictionary 115 are used to populate a selected exemption form 120 on the browser 125 according to a method 300 as described below.

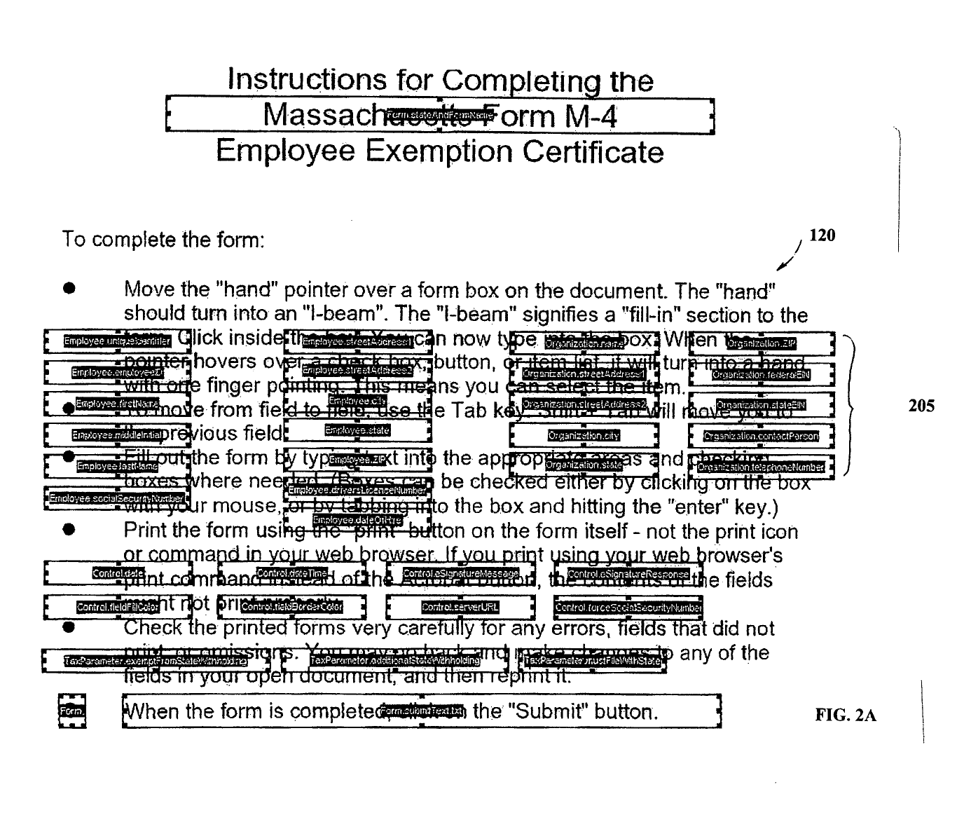

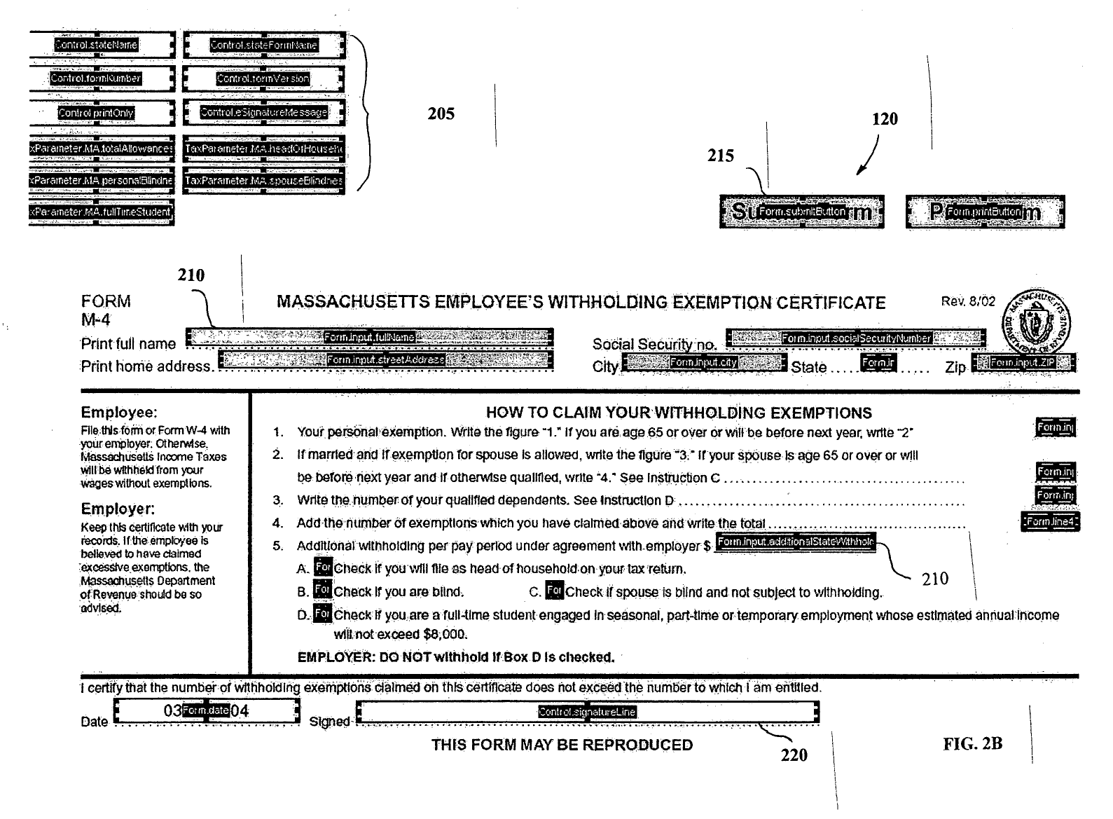

Referring to FIGS. 2A and 2B, there is illustrated an example of an electronic copy of a state employee exemption certificate form 120. An instructions part of the form 120 is shown in FIG. 2A and a submission part of the form 120 is shown in FIG. 2B. Those skilled in the art will appreciate that both parts of the form 120 shown in FIGS. 2A and 2B may appear on a single page on the browser 125. The form 120 includes both hidden fields 205 that are not generally viewable by the employee 130, and visible fields 210 that are generally viewable by the employee 130. Further details of the form 120 are described below in relation to the method 300 of the present invention.

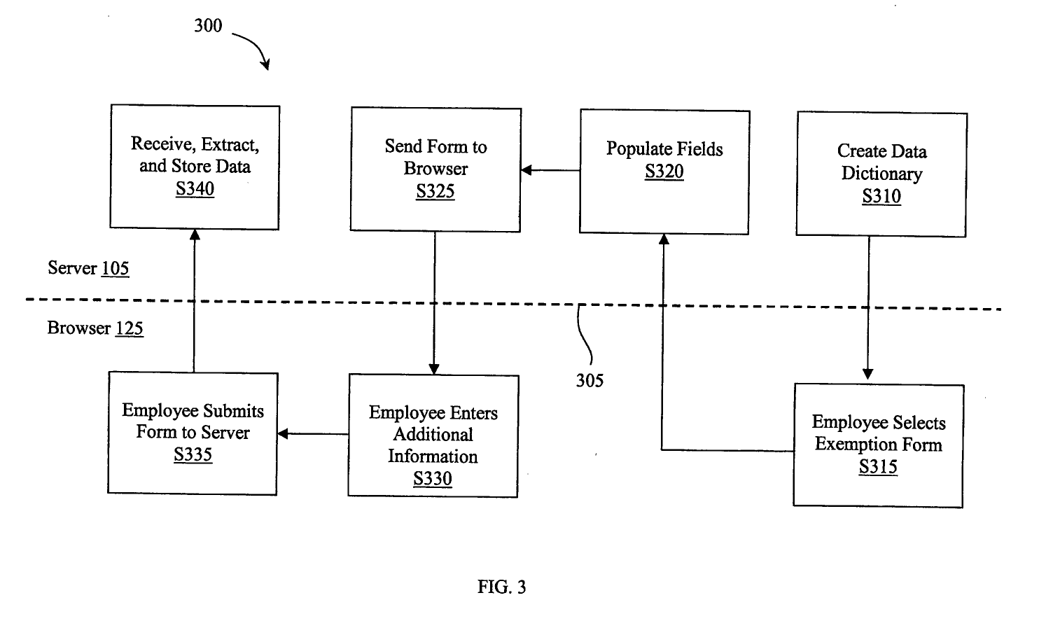

Referring to FIG. 3, there is illustrated a simplified flow diagram of the method 300 of the present invention. The method 300 is implemented through communications between the employer's server 105 and the browser 125. In FIG. 3, steps of the invention occurring on the server 105 are included in the area above the dashed line 305, and steps of the invention occurring on the browser 125 are included in the area below the dashed line 305.

First, at step S310, the data dictionary 115 is created on the server 105. The data dictionary 115 includes fields from one or more of the employee information, employer information, tax parameter information, and control information categories, as described in more detail below. Next, at step S315, an employee 130 uses the browser 125 to select a specific employee exemption certificate form 120. The form 120 that is selected by the employee 130 will frequently correspond to the state where the employee 130 resides. In the preferred embodiment, at step S320, one or more data fields 205, 210 in the selected form 120 is populated using information from a pre-populated data dictionary 115. The form 120 is then sent to the employee's browser 125 at step S325. Next, at step S330, the employee 130 enters additional information in the visible fields 210. The additional information may include new information that is added to a blank visible field 210, or may include updated or revised information that is substituted for pre-populated information already in a visible field 210. Some of the fields 205, 210 that may be pre-populated using known employee or company data include, for example, employee name and the number of tax exemptions claimed from the previous year.

The method 300 then continues at step S335 where the employee 130 submits the updated employee exemption certificate form 120 to the server 105. Generally the submission is executed when the employee 130 presses a submit button 215, as illustrated in FIG. 2, on the form 120. Finally, at step S340, the updated form 120 is received at the server 105, data from the visible fields 210 are extracted and the data are stored.

Those skilled in the art will appreciate that the form 120 shown in the browser 125 is the official state form, which ensures that all required information is collected from the employee 130 (a requirement of federal and state law). Note that the exemplary form 120 shown in FIG. 3B is from the State of Massachusetts. According to one embodiment of the present invention, each visible field 210 is validated to make sure it is filled in and that the correct type of information is in the field 210. Where necessary, certain calculations are also made to fill required fields 205, 210. For example, a state may ask for the number of exemptions, then ask the employee 130 to subtract two to determine the final number of exemptions allowed. This calculation of subtracting two may be automatically carried out in the browser 125.

When an employee 130 needs to modify an exemption certificate, all the previously entered data can be reloaded in the form 120 before it is displayed in the browser 125. Such modifications of a form 120 thus occur by restarting the method 300 at step S315.

Those skilled in the art will recognize that various data processing methods may be used to collect, transmit and store data entered into the forms 120. For example, to minimize data storage requirements, data posted from a form 120 is preferably in a string and usually smaller than 2 k in size. Various file formats such as Forms Data Format (FDF) files or XML formatted documents may be used when transmitting form data between the server 105 and the browser 125. Individual data elements may be extracted from the string using known software routines. The string of data may be saved in the Payroll/HR system 110 or the entire completed form 120 may be saved for audit purposes.

Data strings as described above can significantly lower the electronic data storage burden on employers. An employer only needs to store one copy of each state's electronic exemption form 120 for each year. For example, if an auditor requests a copy of an employee's electronically signed form several years after the form 120 was executed, the employer can populate the exemption form 120 for the year in which it was signed with that particular employee's data string for that year, and print out the completed form for the auditor.

State W-4 Forms

Table 1 lists the state withholding allowance certificate forms 120 for every state plus the District of Columbia and Puerto Rico. Table 1 also indicates if the state will accept the Federal W-4 in place of the state form. Many states have no state form: they use the federal W-4. For those states, the form will be the W-4. For the sake of completeness, states without a state income tax are also listed.

TABLE 1

| State Name | Form | Accepts Federal W-4 |
|---|---|---|
| Alabama | A-4 | No |
| Alaska | | No state income tax |
| Arizona | A-4 | No |
| Arkansas | AR4EC | Yes1 |
| California | DE-4 | Yes1 |
| Colorado | W-4 | Yes |
| Connecticut | CT-W4 | No |
| Delaware | W-4 | Yes |
| Florida | | No state income tax |
| Georgia | G-4 | No |
| Hawaii | HW-4 | No |
| Idaho | W-4 | Yes |
| Illinois | IL-W-4 | No |
| Indiana | WH-4 | No |
| Iowa | IA W4 | No |
| Kansas | W-4 | Yes |
| Kentucky | K-4 | No |
| Louisiana | L-4 | No |
| Maine | W-4ME | No |
| Maryland | MW507 | No |
| Massachusetts | M-4 | Yes2 |
| Michigan | MI-W4 | No |
| Minnesota | W-4 | Yes |
| Mississippi | 89-350 | No |
| Missouri | MO W4 | No |
| Montana | W-4 | Yes |
| Nebraska | W-4 | Yes |
| Nevada | | No state income tax |
| New Hampshire | | No state income tax |
| New Jersey | NJ-W4 | Yes1 |
| New Mexico | W-4 | Yes |
| New York | IT-2104 | Yes1 |
| North Carolina | NC-4 | No |
| North Dakota | W-4 | Yes |
| Ohio | IT-4 | No |
| Oklahoma | W-4 | Yes |
| Oregon | W-4 | Yes |
| Pennsylvania | | No certificate |
| | | needed |
| Rhode Island | W-4 | Yes |
| South Carolina | W-4 | Yes |
| South Dakota | | No state income tax |
| Tennessee | | No state income tax |
| Texas | | No state income tax |
| Utah | W-4 | Yes |
| Vermont | W-4VT | Yes1 |
| Virginia | VA-4 | No |
| Washington | | No state income tax |
| West Virginia | WV/IT-104 | Yes1 |
| Wisconsin | WT-4 | Yes1 |
| Wyoming | | No state income tax |
| Washington DC | D-4 | No |
| Puerto Rico | 499 R-4.1 | No |
| American | W-4 | Yes3 |
| Samoa | | |
| Guam | W-4 | Yes3 |
| Mariana Islands | W-4 | Yes3 |
| Virgin Islands | W-4 | Yes3 |

Footnotes
1 State form should be filed if number of allowances and/or additional dollar amount to be withheld for state purposes will be different than on the federal Form W-4.
2 Complete state form only if the number of state and federal allowances are different.
3 State withholding is computed identically as federal withholding. No federal tax is withheld.

Data Dictionary

The data dictionary 115 contains all necessary fields 205, 210 to complete the process of filling out all the forms 120 for all states. The data dictionary 115 is a carefully constructed set of data fields 205, 210 that can be applied across all the forms 120, although some of the data fields 205, 210 may not be used in a given state's form 120. In one embodiment of the present invention, all of the data necessary to populate a particular state's exemption certificate form 120 is included at the employee's browser 125 in the form of hidden fields 205. The hidden fields 205 have their visible attribute set to false, meaning that the employee 130 will not see any of these fields 205. If the value of a hidden field 205 needs to be displayed, the form 120 will copy the values from the hidden fields 205 into temporary visible fields 210 that are visible to the employee 130. Thus, if a state does not require data from a certain hidden field 205, no visible field 210 will appear on the browser 125 for the employee 130 to fill in and the data in that hidden field 205 will not be used to populate that particular state form 120.

The Data Dictionary 115 may be divided into four categories, the employee information, the organization information, the tax parameters, and the control data. These are each discussed below.

Employee Information

The employee information contains all the personal data associated with an employee. Examples include:
Employee.uniqueIdentifier
Employee.employeeID
Employee.firstName
Employee.middleInitial
Employee.lastName
Employee.socialSecurityNumber
Employee.streetAddress1
Employee.streetAddress2
Employee.city
Employee.state
Employee.ZIP
Employee.driversLicenseNumber
Employee.dateOfHire

Organization Information.

The organization information contains information specific to the employer such as name, address, and contact individual. The name “organization” is used herein alternately with “employer”. Examples include:
Organization.name
Organization.streetAddress1
Organization.streetAddress2
Organization.city
Organization.state
Organization.ZIP
Organization.federalEIN
Organization.stateEIN
Organization.contactPerson

Tax Parameter Information

The Tax Parameter category contains the information necessary to properly withhold taxes from an employee paycheck. The information in this category is all that is required to compute a correct payroll calculation. It does not include any of the worksheet fields seen on the forms 120. Although several of the parameters are the same in many of the states, a preferred embodiment of the present invention provides each state with its own set of tax parameters to avoid any confusion.

Examples include:

TaxParameter.exemptFromStateWithholding
TaxParameter.additionalStateWithholding
TaxParameter.mustFileWithState
Filing Status
Total Allowances

The first three parameters listed above are common to all states. The “TaxParameter.exemptFromStateWithholding” datum is a boolean (true or false) field 205, 210 indicating that the employee 130 has indicated on the state form 120 that he or she is exempt from state withholding. The “TaxParameter.additionalStateWithholding” datum is a numeric field 205, 210 where the employee 130 indicates any additional withholding he or she desires above the amount calculated by the state's withholding tax tables. The “TaxParameter.mustFileWithState” datum is a boolean field (true or false) indicating that this form 120 must be sent to the appropriate state government. This occurs when the employee 130 has entered an excessive number of allowances or if the employee 130 has filed that he or she is exempt from withholding. The number that qualifies as an excessive number of allowances varies from state to state. Each of the forms 120 in a preferred embodiment uses the correct number for each state and will set this field 205, 210 to true if the number exceeds the threshold. Table 2 shows which states require certificate forms 120 to be filed and the reason for filing:

TABLE 2

| State | Form | Reason for Required Filing |
|---|---|---|
| Federal | W-4 | Total allowances (Line 5) are more than 10 or employee is filing |
| | | exempt and has wages greater than $200 per week. The |
| | | preferred embodiment cannot monitor the wages of the |
| | | employee but will set the TaxParameter.mustFileWithState as true |
| | | if the employee claims exempt status. |
| AL | | Total allowances are more than 12. |
| CA | DE 4 | Total allowances are more than 10. |
| CO | | Total allowances are more than 10. |
| CT | CT-W4 | Employee has indicated they are exempt from withholding by |
| | | selecting withholding code “E”. |
| DE | | Total allowances are more than 14. |
| GA | G-4 | Total allowances are more than 14 or claiming exempt from |
| | | withholding. |
| HI | HW-4 | Total allowances are more than 10. |
| ID | | Total allowances are more than 10. |
| IL | | Total allowances are more than 14. |
| IA | IA W4 | Total allowances are more than 22. |
| MD | MW 507 | Total allowances are more than 14, or the employee claims to |
| | | be exempt from withholding on Lines 3 or 4 of Form MW 507. |
| MI | MI W4 | Total allowances (Line 6) are more than 9 or employee files |
| | | exempt (Line 8). |
| MT | | Total allowances are more than 10. |
| NC | | Total allowances are more than 10 or employee claims exempt |
| | | status. |
| ND | | Total allowances are more than 10. |
| OR | | Total allowances are more than 10. |
| NY | IT-2104 | Total allowances for New York State is more than 14. |
| PR | | Total allowances are more than 8. |
| SC | | Total allowances are more than 10. |
| DC | D-4 | Total allowances are more than 10. |
| WI | WT-4 | Total allowances are more than 10 or employ claims exempt |
| | | status. |

Table 3 lists the values of the “Filing Status, also referred to as the marital status.

TABLE 3

| Field Value | Explanation |
|---|---|
| “S” | Single |
| “M” | Married |
| “MH” | Married but withhold at higher single rate |
| “H” | Head of household |
| “0” | No personal exemption (Alabama only - number zero not |
| | the letter O) |
| “QW” | Qualifying widow(er) |
| “MJ” | Married filing jointly |
| “MS” | Married filing separately |
| “D” | Certified disabled person (Hawaii only) |
| “M1” | Married - one income |
| “M2” | Married - two incomes |
| “CU” | Civil union (Vermont only) |
| “CUH” | Civil union but withhold at higher single rate |

Appendix A of this specification includes a Table 4 that lists the tax parameter fields 205 for all the states/territories.
The format for the field names is “TaxParameter” + “.” + State Abbreviation + “.” + Field Name.

Control Information

The control information contains hidden control fields 205 that are used to control and maintain information about the form 120 itself and to control the submission process.

Examples include:
Control.date
Control.dateTime
Control.formNumber
Control.formVersion
Control.stateFormName
Control.stateName
Control.formType
Control.fieldFillColor
Control.fieldBorderColor
Control.printOnly
Control.preserveInputFieldValue
Control.previewMode
Control.validateBeforePrint
Control.forceSocialSecurityNumber
Control.eSignatureMessage
Control.eSignatureResponse
Control.signatureLine
Control.serverURL

Generally, an employee's signature must be attached to the submitted form 120 because federal and state laws require that an electronic tax submission must be signed with an electronic signature by the payee whose name is on the form 120 and that the payee must make a declaration under penalty of perjury that the form 120 was submitted by that payee. One embodiment of the present invention uses the following three control data fields 205 to accomplish that:

First, when the employee 130 clicks on the submit button 215, he or she will be presented with a text box containing the message placed in the Control.eSignatureMessage field 205. The message can be customized to the organization. After an alert is displayed, another text box is displayed that requires the employee 130 to confirm the electronic signature process by actually typing in a response word. The required word is the word in the Control.eSignatureResponse field 205. If that word is not typed in, the form 120 is not considered “signed’ by the employee and the submission will not be completed. The Control.signatureLine field 220 is generally empty and is located where the written signature line appears on each form 120. If an employee exemption form 120 must be sent to a government agency the following text should be placed into the Control.signatureLine field 220: Signature on file. This field 220 is used only when printing copies of completed forms 120.

Preferably the invention is implemented on a secure client-server computer system 100. Ideally the system 100 is implemented on a company intranet, so that no data is transmitted over unsecured lines or open lines of the Internet. Preferably a Windows® or UNIX server (AIX, Linux, Solaris) hosts the system 100, using Adobe® FDF Toolkit software, which provides interfaces for C/C++, Java, Perl, and ASP. Alternatively, the server 105 may use the scripting language PHP (Personal Home Pages), which has built-in support for FDF files. While many languages may be used to effect a solution in the browser 125, preferably the browser 125 utilizes Adobe® Acrobat® Reader® 5.0 or newer.

A preferred embodiment of the present invention contains all the state exemption certificates for the U.S. in Adobe Acrobat format. Each State Exemption Certificate form 120 contains a set of standard visible fields 210. The Adobe FDF Toolkit places values into corresponding hidden fields 205 on the server 105 before the PDF form 120 is viewed by the employee 130. To view the necessary hidden fields 205 from the browser 125, JavaScript inside the forms 120 copies the values from the data dictionary 115 to temporary visible fields 210. When the employee 130 has completed entering data into the form 120 and presses the submit button 215, the server 105 will receive (in FDF format) all the fields 205, 210 in the form 120. The FDF Toolkit API extracts the field values and updates the host Payroll/HR system 110.

The following are two examples of the code used to execute the method 300 described herein.

### EXAMPLE 1

### Employee Exemption Certificate Process Program Written in PHP

The following page provides an example of a PHP script that populates a state exemption certificate form 120. For illustration purposes, we assume the state to be Georgia and the form is G-4 (Rev. 11/02). The server 105 is located at www.mytest.com. The script name is “fdftest.php”. In a browser 125, an employee 130 would connect to http://www.mytest.com/fdftest.php. After creating the FDF file, the script sends it to the browser 125 that starts up Acrobat Reader. Acrobat then interprets the FDF file and loads the PDF file (which is specified using a fdf_set_file function) and populates the visible fields 210 in the PDF form 120 with the values from the FDF file.

```
<?php
  /* set content type for Adobe FDF */
  fdf_header( );
  /* start new fdf */
  $fdf = fdf_create( );
```

| | |
|---|---|
| /* | You will connect to your HR/Payroll system to retrieve the values that |
| | will be used to populate the fields in the PDF documents. The field |
| | names are from the Employee Exemption Certificate SDK Data |

```
Dictionary.
      */
  /* set field values */
  fdf_set_value($fdf, “Employee.uniqueIdentifier”, “E184290”);
  fdf_set_value($fdf, “Employee.firstName”, “Dennis”);
  fdf_set_value($fdf, “Employee.middleInitial”, “M”);
  fdf_set_value($fdf, “Employee.lastName”, “Wilson”);
  fdf_set_value($fdf, “Employee.socialSecurityNumber”, “840-56-1982”);
  fdf_set_value($fdf, “Employee.streetAddress1”, “10040 E. Happy Valley Road”);
  fdf_set_value($fdf, “Employee.streetAddress2”, “#416”);
  fdf_set_value($fdf, “Employee.city”, “Scottsdale”);
  fdf_set_value($fdf, “Employee.state”, “AZ”);
  fdf_set_value($fdf, “Employee.ZIP”, “85255”);
  fdf_set_value($fdf, “Organization.name”, “Symmetry Software”);
  fdf_set_value($fdf, “Organization.streetAddress1”, “8418 E. Shea Blvd.”);
  fdf_set_value($fdf, “Organization.streetAddress2”, “Suite 101”);
  fdf_set_value($fdf, “Organization.city”, “Scottsdale”);
  fdf_set_value($fdf, “Organization.state”, “AZ”);
  fdf_set_value($fdf, “Organization.ZIP”, “85260”);
  fdf_set_value($fdf, “Organization.federalEIN”, “86-12345678”);
  fdf_set_value($fdf, “Organization.stateEIN”, “123-4567”);
  /*  Set the address of the page where the POSTed results will be sent */
  fdf_set_value($fdf, “Control.serverURL”, “http://www.mytest.com/fdfproc.php”);
  /* tell client to display FDF data */
  fdf_set_file($fdf, “http://www.mytest.com/G-4-rev12000.pdf”);
  /* output fdf */
  fdf_save($fdf);
  /* clean up */
  fdf_close( );
?>
```

The following script named “fdfproc.php” will run when the employee 130 clicks on the “Submit” button 215 in the PDF form 120 (step S335 from FIG. 3). The FDF data will be sent via a HTTP POST method to the script. The script displays the name/value pairs from all the fields 205, 210 returned from the PDF form 120.

```
<html>
<head>
<title>Symmetry State W4 Test Page</title>
<meta http-equiv=“Content-Type” content=“text/html;
charset=iso-8859-1”>
</head>
<body>
<p>FDF Data Returned from Browser</p>
<table width=“600” border=“1” cellspacing=“0” cellpadding=“0”>
  <tr>
    <td><strong>Field Name</strong></td>
    <td><strong>Return Value</strong></td>
  </tr>
<?php
```

| | |
|---|---|
| /* | Read the FDF data, store it in a database, extract individual |
| | fields to update the HR/Payroll system. This example prints out |
| | all the fields and values that were returned from the browser. |
| */ | |

$fdf = fdf_open_string($GLOBALS[“HTTP_FDF_DATA”]);
if ( $fdf==null )

echo “Unable to read FDF data”;

else
{

for( $field = fdf_next_field_name($fdf);

$field != “”;
$field = fdf_next_field_name($fdf, $field) )

{

echo “<tr><td>” . $field . “</td><td>”

. fdf_get_value($fdf,$field) . “</td></tr>”;

}
fdf_close($fdf);

}
?>
</table>
<p>&nbsp; </p>
</body>
</html>

### EXAMPLE 2

### Employee Exemption Certificate Process Program Written in ASP

The following provides an example of an ASP script that populates a state exemption certificate form 120. For illustration purposes, we assume the state to be Georgia and the form is G-4 (Rev. 11/02). After creating the FDF, the script sends it to the browser 120 that starts up Acrobat Reader. Acrobat then interprets the FDF and loads the PDF file (which is specified using the FDFSetFile function) and populates the visible fields 210 in the PDF form 120 with the values from the FDF.

Set FdfAcx = Server.CreateObject(“FdfApp.FdfApp”)
Set FDF = FdfAcx.FDFCreate
‘ Fill in the FDF
FDF.FDFSetValue “Form.input.fullName”, Request.Form(“name”), False
FDF.FDFSetValue “Form.input.socialSecurityNumber”,
Request.Form(“ssn”), False
FDF.FDFSetValue “Form.input.streetAddress”, Request.Form(“addr”),
False
FDF.FDFSetValue “Employee.employeeID”, Request.Form(“ID”), False
FDF.FDFSetValue “Control.serverURL”, Request.Form(“submitaction”),
False
‘ Set the pdf file to return to the browser
FDF.FDFSetFile
“http://“+Request.ServerVariables(“SERVER_NAME”)+”/statew4/G-4-
rev12000.pdf”
Response.ContentType = “application/vnd.fdf”
‘ Send the fdf to the browser
Response.BinaryWrite FDF.FDFSaveToBuf
‘ Close the FDF object
FDF.FDFClose

The following script will run when the user clicks on the “Submit” button in the PDF form (step S335 from FIG. 3). The FDF data will be sent via a HTTP POST method to the script. The script displays the name/value pairs from all the fields 205, 210 returned from the PDF form 120.

```
on error resume next
Set FdfAcX = Server.CreateObject(“FdfApp.FdfApp”)
Set outputFDF =
FdfAcX.FDFOpenFromBuf(Request.BinaryRead(Request.TotalBytes))
stringToDisplay = “”
strFirstField = outputFDF.FDFNextFieldName(“”) ‘get first field name
do while len(strFirstField) > 0
stringToDisplay = stringToDisplay & strFirstField
tempValue=outputFDF.FDFGetValue(strFirstField)
if err.number <> 0 then
    stringToDisplay = stringToDisplay & “=“&err.description&”,<BR>”
    err.clear
else
    stringToDisplay = stringToDisplay & “=“ & tempValue & ”,<BR>”
end if
strFirstField = outputFDF.FDFNextFieldName (strFirstField)
loop
response.write stringToDisplay
response.End( )
```

While there has been illustrated and described what is at present considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiments disclosed as preferred for carrying out the invention, but that the invention will include all embodiments falling within the scope of the appended claims.

1. A method in a computer system for completing an employee exemption certificate form, the method comprising:
a) saving a data dictionary on a server, wherein the data dictionary comprises tax parameter data fields for more than one state;
b) sending an employee exemption certificate form having one or more tax parameter data fields to a browser;
c) entering employee information into the employee exemption certificate form from the browser to complete an updated employee exemption certificate form;
d) submitting the updated employee exemption certificate form to the server;
e) receiving the updated employee exemption certificate form at the server; and
f) extracting and storing data from the updated employee exemption certificate form.

2. A method in a computer system for creating an employee exemption certificate form, the method comprising the steps of:
a) saving a data dictionary on a server, wherein the data dictionary comprises:
i. employee information;
ii. employer information;
iii. tax parameter information; and
iv. control information;
b) utilizing the employee information to select an employee exemption certificate form, the form having one or more data fields;
c) populating one or more data fields in the employee exemption certificate form using information from the data dictionary;
d) sending the employee exemption certificate form to a browser;
e) entering additional employee information into the employee exemption certificate form from the browser to create an updated employee exemption certificate form;
f) submitting the updated employee exemption certificate form to the server; and
g) receiving the updated employee exemption certificate form at the server, extracting data from the submitted form and storing the extracted data.

3. The method according to claim 2 further comprising entering an electronic signature response into the employee exemption certificate form from the browser.

4. The method according to claim 2, wherein the method is executed on an employer's intranet.

5. The method according to claim 2, wherein the employee information is selected from the group consisting of employee first name, employee middle name, employee last name, employee social security number, employee state of residence, employee address, employee city, employee state, employee zip code, employee drivers license number, and employee date of hire.

6. The method according to claim 2, wherein the employer information is selected from the group consisting of employer name, employer address, employer city, employer state, employer zip code, employer federal EIN, employer state EIN, and employer contact person.

7. The method according to claim 2, wherein the tax parameter information is selected from the group consisting of filing status, total allowances, total number of dependents, total exemptions, percentage of federal withholding, regular allowances, additional allowances, withholding code, personal exemptions, dependent exemptions, county of residence, county of employment, head of household status, personal blindness exemption, spouse blindness exemption, student status, total state allowances, total city allowances, additional city withholdings, school district number, and two earner percent method.

8. The method according to claim 2, further comprising the step of validating one or more fields in the updated employee exemption certificate form before submitting the updated employee exemption certificate form to the server.

9. The method according to claim 2, further comprising the step of computing the value of certain tax parameter information using the employee information.

10. The method according to claim 2, further comprising the step of embedding control information in the certificate form.

11. The method according to claim 9, wherein the control information comprises fields selected from the following group: date, dateTime, formNumber, formVersion, stateFormName, statename, fieldFillColor, fieldBorderColor, printOnly, forceSocialSecurityNumber, eSignatureMessage, eSignatureResponse, signatureLine, and serverURL.

12. The method according to claim 9, wherein the method is implemented on a Windows or UNIX server using the Adobe FDF Toolkit.

13. The method according to claim 9, wherein the employee exemption certificate form is selected from a plurality of employee exemption certificate forms, where each form corresponds to a single U.S. state.

14. The method according to claim 9, wherein the data dictionary includes fields for populating employee exemption certificate forms from all U.S. states.

15. The method according to claim 13, wherein the data fields in the exemption certificate form are a subset of the fields in the data dictionary.

16. The method according to claim 9, wherein the employee exemption certificate form is populated using a Personal Home Pages (PHP) or Active Server Pages (ASP) script.

17. The method according to claim 9, wherein some of the data fields are hidden fields and wherein some of the data fields are visible fields.

18. The method according to claim 17, further comprising the step of copying in the browser a value from at least one of the hidden fields to at least one of the visible fields.

19. A computer program product for processing employee exemption certificate forms, the product comprising computer readable program code devices for:
a) saving a data dictionary on a server, wherein the data dictionary comprises:
i. employee information;
ii. employer information;
iii. tax parameter information; and
iv. control information;
b) utilizing the employee information to select an employee exemption certificate form, the form having one or more data fields;
c) populating one or more data fields in the employee exemption certificate form using information from the data dictionary;
d) sending the employee exemption certificate form to a browser;
e) entering additional employee information into the employee exemption certificate form from the browser to create an updated employee exemption certificate form;
f) submitting the updated employee exemption certificate form to the server; and
g) receiving the updated employee exemption certificate form at the server, extracting data from the submitted form and storing the extracted data.

20. The product according to claim 19 further comprising program code devices for entering an electronic signature response into the employee exemption certificate form from the browser.

21. The product according to claim 19, wherein the employee information is selected from the group consisting of employee first name, employee middle name, employee last name, employee social security number, employee state of residence, employee address, employee city, employee state, employee zip code, employee drivers license number, and employee date of hire.

22. The product according to claim 19, wherein the employer information is selected from the group consisting of employer name, employer address, employer city, employer state, employer zip code, employer federal EIN, employer state EIN, and employer contact person.

23. The product according to claim 19, wherein the tax parameter information is selected from the group consisting of filing status, total allowances, total number of dependents, total exemptions, percentage of federal withholding, regular allowances, additional allowances, withholding code, personal exemptions, dependent exemptions, county of residence, county of employment, head of household status, personal blindness exemption, spouse blindness exemption, student status, total state allowances, total city allowances, additional city withholdings, school district number, and two earner percent method.

24. The product according to claim 19, further comprising the step of validating one or more fields in the updated employee exemption certificate form before submitting the updated employee exemption certificate form to the server.

25. The product according to claim 19, further comprising the step of computing the value of certain tax parameter information using the employee information.

26. The system according to claim 19, further comprising the step of embedding control information in the certificate form.

27. The product according to claim 26, wherein the control information comprises fields selected from the following group: date, dateTime, formNumber, formVersion, stateFormName, statename, fieldFillColor, fieldBorderColor, printOnly, forceSocialSecurityNumber, eSignatureMessage, eSignatureResponse, signatureLine, and serverURL.

28. The product according to claim 19, wherein the system is implemented on a Windows or UNIX server using the Adobe FDF Toolkit.

29. The product according to claim 19, wherein the employee exemption certificate form is selected from a plurality of employee exemption certificate forms where each form corresponds to a single U.S. state.

30. The product according to claim 19, wherein the data dictionary includes fields for populating employee exemption certificate forms from all 50 U.S. states.

31. The product according to claim 30, wherein the data fields in the exemption certificate form are a subset of the fields in the data dictionary.

32. The product according to claim 19, wherein the employee exemption certificate form is populated using a Personal Home Pages (PHP) or Active Server Pages (ASP) script.

33. The product according to claim 19, wherein some of the data fields are hidden fields and wherein some of the data fields are visible fields.

34. The product according to claim 33, further comprising program code devices for copying in the browser a value from at least one of the hidden fields to at least one of the visible fields.
TABLE 4

| | | Form/Line | | |
|---|---|---|---|---|
| State | Field Name | Number | Description | Valid Data |
| Federal W-4 | TaxParameter.FED.filingStatus | W-4 | Filing status | “S”—single, “M”— |
| | | Line 3 | | married, “MH”— |
| | | | | married but withhold at |
| | | | | higher single rate |
| Federal W-4 | TaxParameter.FED.totalAllowances | W-4 | Total | Any integer value |
| | | Line 5 | allowances | |
| Federal W-4 | TaxParameter.FED.additionalFedWithholding | W-4 | Optional | Any integer value |
| | | Line 6 | additional | |
| | | | federal | |
| | | | withholding | |
| Federal W-4 | TaxParameter.FED.exemptFromFedWithholding | W-4 | Exempt from | true, false |
| | | Line 7 | Federal | |
| | | | Withholding | |
| Federal W-4 | TaxParameter.FED.mustFileWithFederal | W-4 | Flag indicating | true, false |
| | | Line 5, Line 7 | excess | |
| | | | allowances or | |
| | | | exempt status | |
| Federal W-5 | TaxParameter.W5.qualifyingChild | W-5 | Flag indicating | true, false |
| | | Line 1 | a qualifying | |
| | | | child | |
| Federal W-5 | TaxParameter.W5.filingStatus | W-5 | Filing Status | “S”—single, “M”— |
| | | Line 2 | | married |
| Federal W-5 | TaxParameter.W5.spouseFilingW5 | W-5 | Flag indicating | true, false |
| | | Line 3 | if spouse also | |
| | | | filing W-5 | |
| AL | TaxParameter.AL.dependents | A-4 | Total number | Any integer value |
| | | Line 3 | of dependents | |
| AL | TaxParameter.AL.filingStatus | A-4 | Filing status | “S”—single, “M”— |
| | | Line 1 or 2 | | married, “H”—head of |
| | | | | household, “0”—no |
| | | | | personal exemption |
| | | | | (number zero not letter |
| | | | | O) |
| AR | TaxParameter.AR.totalAllowances | AR4EC | Total | Any integer value |
| | | Line 3 | exemptions | |
| AS | American Samoa uses the federal W-4 filing | | | |
| (American | status and allowances. No form exists for | | | |
| Samoa) | American Samoa. | | | |
| AZ | TaxParameter.AZ.percentFederal | A-4 | Percentage of | 0, 10, 18.2, 21.3 23.3, |
| | | Lines 1, 2, 3 | federal w/h | 29.4, 34.4 |
| CA | TaxParameter.CA.filingStatus | DE 4 | Filing status | “S”—single or married |
| | | | | with two or more |
| | | | | incomes, “M”— |
| | | | | married with one |
| | | | | income, “H”—head of |
| | | | | household |
| CA | TaxParameter.CA.regularAllowances | DE 4 | Regular | Any integer value |
| | | | allowances | |
| | | | Line 1 - | |
| | | | Worksheet A | |
| CA | TaxParameter.CA.additionalAllowances | DE 4 | Additional | Any integer value |
| | | | allowances | |
| | | | Line 1 - | |
| | | | Worksheet B | |
| CO | Colorado uses the federal W-4 filing status and | | | |
| | allowances. No form exists for Colorado. | | | |
| CT | TaxParameter.CT.withholdingCode | CT-W4 | Withholding | Letters “A” through |
| | | Line 1 | code | “F”. |
| CT | TaxParameter.CT.reducedWHAmount | CT-W4 | Withholding | Any dollar amount |
| | | Line 3 | reduction | |
| | | | amount | |
| CT | TaxParameter.CT.percentServices | CT-W4NA | Percent of | Integer value 0 through |
| | | | services | 100 |
| | | | performed in | |
| | | | CT | |
| DC | TaxParameter.DC.filingStatus | D-4 | Filing status | “S”—single, “MJ”— |
| | | | | married filing jointly, |
| | | | | “MS”—married filing |
| | | | | separately, “H”—head |
| | | | | of household. |
| DC | TaxParameter.DC.totalAllowances | D-4 | Total | Any integer value |
| | | Line 1 | allowances | |
| DE | TaxParameter.DE.filingStatus | W-4 | Filing status | “S”—single, “M”— |
| | | Line 3 | | married, “MH”— |
| | | | | married but withhold at |
| | | | | higher single rate |
| DE | TaxParameter.DE.totalAllowances | W-4 | Total | Any integer value |
| | | Line 5 | allowances | |
| GA | TaxParameter.GA.filingStatus | G-4 | Filing status | Letters “A” through |
| | | Line 7 | | “E” |
| GA | TaxParameter.GA.totalAllowances | G-4 | Total | Any integer value |
| | | Line 7 | allowances | |
| GU | Guam uses the federal W-4 filing status and | | | |
| (Guam) | allowances. No form exists for Guam. | | | |
| HI | TaxParameter.HI.filingStatus | HW-4 | Filing status | “S”—single, “M”— |
| | | Line 3 | | married, “MH”— |
| | | | | married but withhold at |
| | | | | higher single rate, “D”— |
| | | | | certified disabled |
| | | | | person |
| HI | TaxParameter.HI.totalAllowances | HW-4 | Total | Any integer value |
| | | Line 4 | allowances | |
| IA | TaxParameter.IA.totalAllowances | IA W4 | Total | Any integer value |
| | | Line 5 | allowances | |
| ID | TaxParameter.ID.filingStatus | W-4 | Filing status | “S”—single, “M”— |
| | | Line 3 | | married, “MH”— |
| | | | | married but withhold at |
| | | | | higher single rate |
| ID | TaxParameter.ID.totalAllowances | W-4 | Total | Any integer value |
| | | Line 5 | allowances | |
| IL | TaxParameter.IL.basicAllowances | IL-W-4 | Basic | Any integer value |
| | | Line 1 | allowances | |
| IL | TaxParameter.IL.additionalAllowances | IL-W-4 | Additional | Any integer value |
| | | Line 2 | allowances | |
| IN | TaxParameter.IN.personalExemptions | WH-4 | Personal | Any integer value |
| | | Line 4 | exemptions | |
| IN | TaxParameter.IN.dependentExemptions | WH-4 | Dependent | Any integer value |
| | | Line 5 | exemptions | |
| IN | TaxParameter.IN.residentCounty | WH-4 | Residence | County name |
| | | | county | |
| IN | TaxParameter.IN.employmentCounty | WH-4 | Employment | County name |
| | | | county | |
| KS | Kansas uses the federal W-4 filing status and | | | |
| | allowances. No form exists for Kansas. | | | |
| KY | TaxParameter.KY.totalAllowances | K-4 | Total | Any integer value |
| | | Line 7 | allowances | |
| LA | TaxParameter.LA.totalAllowances | L-4 | Total | 0, 1, or 2 |
| | | Line 6 | allowances | |
| LA | TaxParameter.LA.totalDependents | L-4 | Total | Any integer value |
| | | Line 7 | dependents | |
| MA | TaxParameter.MA.totalAllowances | M-4 | Total | Any integer value |
| | | Line 4 | allowances | |
| MA | TaxParameter.MA.headOfHousehold | M-4 | Head of | true, false |
| | | Line 5A | household | |
| | | | filing status | |
| MA | TaxParameter.MA.personalBlindness | M-4 | Personal | true, false |
| | | Line 5B | blindness | |
| | | | exemption | |
| MA | TaxParameter.MA.spouseBlindness | M-4 | Spouse | true, false |
| | | Line 5C | blindness | |
| | | | exemption | |
| MA | TaxParameter.MA.fullTimeStudent | M-4 | Full time | true, false |
| | | Line 5D | student | |
| MD | TaxParameter.MD.totalAllowances | MW 507 | Total | Any integer value |
| | | Line 1 | allowances | |
| MD | TaxParameter.MD.residentCounty | MW 507 | Residence | County name |
| | | | county | |
| ME | TaxParameter.ME.filingStatus | W-4ME | Filing status | “S”—single, “M1”— |
| | | Line 3 | | married one income, |
| | | | | “M2”—married two |
| | | | | incomes |
| ME | TaxParameter.ME.totalAllowances | W-4ME | Total | Any integer value |
| | | Line 4 | allowances | |
| MI | TaxParameter.MI.totalAllowances | MI-W4 | Total | Any integer value |
| | | Line 6 | allowances | |
| MI | TaxParameter.MI.additionalLocalWithholding | | Additional | Any dollar amount |
| | | | City | |
| | | | Withholding | |
| MI (city of | TaxParameter.MI.Albion.totalAllowances | AL-W4 | Total | Any integer value |
| Albion) | | Line 7 | allowances | |
| MI (city of | TaxParameter.MI.BattleCreek.totalAllowances | BCW-4 | Total | Any integer value |
| Battle | | Line 7 | allowances | |
| Creek | | | | |
| MI (city of | TaxParameter.MI.Detroit.totalAllowances | DW-4 | Total | Any integer value |
| Detroit) | | Line 7 | allowances | |
| MI (city of | TaxParameter.MI.GrandRapids.totalAllowances | GRW-4 | Total | Any integer value |
| Grand | | Line 7 | allowances | |
| Rapids) | | | | |
| MI (city of | TaxParameter.MI.Ionia.totalAllowances | IW-4 | Total | Any integer value |
| Ionia) | | Line 7 | allowances | |
| MI (city of | TaxParameter.MI.Jackson.totalAllowances | JW-4 | Total | Any integer value |
| Jackson) | | Line 7 | allowances | |
| MI (city of | TaxParameter.MI.Lapeer.totalAllowances | LW-4 | Total | Any integer value |
| Lapeer) | | Line 7 | allowances | |
| MI (city of | TaxParameter.MI.Muskegon.totalAllowances | MW-4 | Total | Any integer value |
| Muskegon) | | Line 7 | allowances | |
| MI (city of | TaxParameter.MI.Pontiac.totalAllowances | PW-4 | Total | Any integer value |
| Pontiac) | | Line 7 | allowances | |
| MI (city of | TaxParameter.MI.Portland.totalAllowances | PW-4 | Total | Any integer value |
| Portland) | | Line 6 | allowances | |
| MI (city of | TaxParameter.MI.Springfield.totalAllowances | SF W-4 | Total | Any integer value |
| Springfield) | | Line 6 | allowances | |
| MI (city of | TaxParameter.MI.Walker.totalAllowances | WW-4 | Total | Any integer value |
| Walker) | | Line 7 | allowances | |
| MN | TaxParameter.MN.filingStatus | W-4 | Filing status | “S”—single, “M”— |
| | | Line 3 | | married, “MH”— |
| | | | | married but withhold at |
| | | | | higher single rate |
| MN | TaxParameter.MN.totalAllowances | W-4 | Total | Any integer value |
| | | Line 5 | allowances | |
| MO | TaxParameter.MO.filingStatus | MO W-4 | Filing status | “S”—single, “M”— |
| | | | | married, “H”—head of |
| | | | | household |
| MO | TaxParameter.MO.totalAllowances | MO W-4 | Total | Any integer value |
| | | Line 5 | allowances | |
| MP | Northern Mariana Islands uses the federal W-4 | | | |
| (Northern | filing status and allowances. No form exists for | | | |
| Mariana | Northern Mariana Islands. | | | |
| Islands) | | | | |
| MS | TaxParameter.MS.filingStatus | 89-350-98 1 | Filing status | “S”—single, “M1”— |
| | | | | married one spouse |
| | | | | working, “M2”— |
| | | | | married both spouses |
| | | | | working, “H”—head of |
| | | | | household |
| MS | TaxParameter.MS.totalExemptionAmt | 89-350-98 1 | Total | Any dollar amount |
| | | Line 6 | exemption | |
| | | | amount | |
| MT | TaxParameter.MT.totalAllowances | W-4 | Total | Any integer value |
| | | Line 5 | allowances | |
| MT | TaxParameter.MT.filingStatus | W-4 | Filing status | “S”—single, “M”— |
| | | Line 3 | | married, “MH”— |
| | | | | married but withhold at |
| | | | | higher single rate |
| NC | TaxParameter.NC.filingStatus | NC-4 | Filing status | “S”—single, “M”— |
| | | Line 3 | | married or qualifying |
| | | | | widow(er), “H”—head |
| | | | | of household |
| NC | TaxParameter.NC.totalAllowances | NC-4 | Total | Any integer value |
| | | Line 4 | allowances | |
| ND | North Dakota uses the federal W-4 filing status | | | |
| | and allowances. No form exists for North | | | |
| | dakota. | | | |
| NE | Nebraska uses the federal W-4 filing status and | | | |
| | allowances. No form exists for Nebraska. | | | |
| NJ | TaxParameter.NJ.filingStatus | NJ-W4-WT | Filing status | “S”—single, “MJ”— |
| | | Line 2 | | married filing joint, |
| | | | | “MS”—married filing |
| | | | | separate, “H”—head of |
| | | | | household, “QW”— |
| | | | | qualifying widow(er) |
| NJ | TaxParameter.NJ.rateTable | NJ-W4-WT | Rate table | Letter “A” through “E” |
| | | Line 3 | | |
| NJ | TaxParameter.NJ.totalAllowances | NJ-W4-WT | Filing status | Any integer value |
| | | Line 4 | | |
| NM | TaxParameter.NM.filingStatus | W-4 | Filing status | “S”—single, “M”— |
| | | Line 3 | | married, “MH”— |
| | | | | married but withhold at |
| | | | | higher single rate |
| NM | TaxParameter.NM.totalAllowances | W-4 | Total | Any integer value |
| | | Line 5 | allowances | |
| NY | TaxParameter.NY.filingStatus | IT-2104 | Filing status | “S”—single or head of |
| | | | | household “M”— |
| | | | | married, “MH”— |
| | | | | married but withhold at |
| | | | | higher single rate, |
| | | | | “QW”—qualifying |
| | | | | widow(er) |
| NY | TaxParameter.NY.totalAllowances | IT-2104 | Total | Any integer value |
| | | Line 1 | allowances | |
| | | | NY state | |
| NY | TaxParameter.NY.totalAllowancesNYC | IT-2104 | Total | Any integer value |
| | | Line 2 | allowances | |
| | | | NY City | |
| NY | TaxParameter.NY.additionalWH-NYC | IT-2104 | Additional NY | Any dollar amount |
| | | Line 4 | City | |
| | | | withholding | |
| NY | TaxParameter.NY.additionalWH-Yonkers | IT-2104 | Additional | Any dollar amount |
| | | Line 5 | Yonkers | |
| | | | withholding | |
| OH | TaxParameter.OH.schoolDistrictNo | IT-4 | School district | School district number |
| | | | number | |
| OH | TaxParameter.OH.totalAllowances | IT-4 | Total | Any integer value |
| | | Line 4 | allowances | |
| OK | TaxParameter.OK.filingStatus | W-4 | Filing status | “S”—single, “M”— |
| | | Line 3 | | married, “M2”— |
| | | | | married dual income, |
| | | | | “MH”—married but |
| | | | | withhold at higher |
| | | | | single rate |
| OK | TaxParameter.OK.totalAllowances | W-4 | Total | Any integer value |
| | | Line 5 | allowances | |
| OR | TaxParameter.OR.filingStatus | W-4 | Filing status | “S”—single, “M”— |
| | | Line 3 | | married, “MH”— |
| | | | | married but withhold at |
| | | | | higher single rate |
| OR | TaxParameter.OR.totalAllowances | W-4 | Total | Any integer value |
| | | Line 5 | allowances | |
| PA | TaxParameter.PA.reciprocalState | REV-420 AS | Employee | Indiana, Maryland, |
| | | (10-99)(I) | resident state | Ohio, New Jersey, |
| | | | | Virginia, West Virginia |
| PR | TaxParameter.PR.personalExemption | 499-R4 | Personal | “SingleComplete”, |
| | | Box A | Exemption | “SingleNone”, |
| | | | | “MarriedComplete”, |
| | | | | “MarriedHalf”, |
| | | | | “MarriedNone”, |
| | | | | “HeadComplete” |
| | | | | “HeadNone” |
| PR | TaxParameter.PR.numberDependents | 499-R4 | Number of | Any integer value |
| | | Box B | dependents | |
| PR | TaxParameter.PR. | 499-R4 | Allowance | “GovEmpComplete”— |
| | allowanceBasedOnDeductionsAutomatic | Box C | based on | governmental |
| | | | deduction - | employee taking |
| | | | automatic | complete allowance, |
| | | | method | “GovEmpNone”— |
| | | | | governmental |
| | | | | employee taking no |
| | | | | allowance, |
| | | | | “PrivateEmpComplete”— |
| | | | | private business |
| | | | | employee taking |
| | | | | complete allowance, |
| | | | | “PrivateEmpNone”— |
| | | | | private business |
| | | | | employee taking no |
| | | | | allowance |
| PR | TaxParameter.PR. | 499-R4 | Allowance | Any integer value |
| | allowanceBasedOnDeductionsOptional | Box C | based on | |
| | | | deduction - | |
| | | | optional | |
| | | | method | |
| PR | TaxParameter.PR.retirementPlan | 499-R4 | If you are a | true, false |
| | | Box C | governmental | |
| | | | employee and | |
| | | | accepted the | |
| | | | withholding | |
| | | | supplementary | |
| | | | plan for | |
| | | | retirement, | |
| RI | TaxParameter.RI.filingStatus | W-4 | Filing status | “S”—single, “M”— |
| | | Line 3 | | married, “MH”— |
| | | | | married but withhold at |
| | | | | higher single rate |
| RI | TaxParameter.RI.totalAllowances | W-4 | Total | Any integer value |
| | | Line 5 | allowances | |
| SC | TaxParameter.SC.filingStatus | W-4 | Filing status | “S”—single, “M”— |
| | | Line 3 | | married, “MH”— |
| | | | | married but withhold at |
| | | | | higher single rate |
| SC | TaxParameter.SC.totalAllowances | W-4 | Total | Any integer value |
| | | Line 5 | allowances | |
| UT | Utah uses the federal W-4 filing status and | | | |
| | allowances. No form exists for Utah. | | | |
| VA | TaxParameter.VA.totalAllowances | VA-4 | Total | Any integer value |
| | | Line 1 | allowances | |
| VT | TaxParameter.VT.filingStatus | W-4VT | Filing Status | “S”—single, “M”— |
| | | Part 4a | | married, “MH”— |
| | | | | married but withhold at |
| | | | | higher single rate, |
| | | | | “CU”—civil union, |
| | | | | “CUH”—civil union |
| | | | | but withhold at higher |
| | | | | single rate |
| VT | TaxParameter.VT.totalAllowances | W-4VT | Total | Any integer value |
| | | Part 4b | allowances | |
| VI | The Virgin Islands uses the federal W-4 filing | | | |
| (Virgin | status and allowances. No form exists for the | | | |
| Islands) | Virgin Islands. | | | |
| WI | TaxParameter.WI.filingStatus | WT-4 | Filing Status | “S”—single, “M”— |
| | | | | married, “MH”— |
| | | | | married but withhold at |
| | | | | higher single rate |
| WI | TaxParameter.WI.totalAllowances | WT-4 | Total | Any integer value |
| | | Line 1 | allowances | |
| WI | TaxParameter.WI.withholdingAmount | WT-4A | Calculated | Any integer value |
| | | | amount to | |
| | | | withhold | |
| WV | TaxParameter.WV.totalAllowances | WV/IT-104 | Total | Any integer value |
| | | Line 4 | allowances | |
| WV | TaxParameter.WV.twoEarnerPercent | WV/IT-104 | Two earner | true, false |
| | | Line 5 | percent | |
| | | | method | |
